(19) United States
(12) Patent Application Publication
(10) Pub. No.: US 2016/0327946 A1
(43) Pub. Date: Nov. 10, 2016

(54) INFORMATION PROCESSING DEVICE, INFORMATION PROCESSING METHOD, TERMINAL DEVICE, AND SETTING METHOD

(71) Applicant: FUJITSU LIMITED, Kawasaki-shi (JP)

(72) Inventors: Susumu Koga, Kawasaki (JP); Junichi Ninomiya, Kawasaki (JP); Hiroshi Kuwabara, Suginami (JP)

(21) Appl. No.: 15/139,999

(22) Filed: Apr. 27, 2016

(30) Foreign Application Priority Data
May 8, 2015 (JP) 2015-096105

(51) Int. Cl. G05D 1/00; B64D 47/08; B64C 39/02; G06T 19/00

(52) U.S. Cl. CPC G05D 1/0038; G06T 19/006; B64D 47/08; B64C 39/024

(57) ABSTRACT

An information processing device includes a memory and a processor. The memory stores a content in association with positional information, the content being to be displayed in a superimposed manner on an AR display terminal, the processor executes a process including: receiving, from a terminal device capable of sending a signal for setting a target position of an unmanned aerial vehicle, specification of any one of contents stored in the memory and outputting positional information corresponding to a content specified in the received specification to the terminal device.

### CROSS-REFERENCE TO RELATED APPLICATIONS

This application is based upon and claims the benefit of priority of the prior Japanese Patent Application No. 2015-096105, filed on May 8, 2015, the entire contents of which are incorporated herein by reference.

### FIELD

The embodiments discussed herein are related to an information processing device, a computer program product, an information processing method, a terminal device, a setting method, and a computer program product.

### BACKGROUND

In recent years, unmanned aerial vehicles have become a focus of attention. An unmanned aerial vehicle or an unmanned air vehicle is abbreviated as an UAV. Examples of an unmanned aerial vehicle include a multicopter such as a drone.

An unmanned aerial vehicle is flown essentially usinq radio control, and there are various types of unmanned aerial vehicles such as unmanned aerial vehicles that, are flown while visually confirming the sight thereof or unmanned aerial vehicles that are controllable even from the opposite side of the earth using a satellite circuit. Besides, some unmanned aerial vehicles have positional information set therein in advance as the flight route and are thus capable of taking an autonomous flight with the aid of the global positioning system (GPS). Such unmanned aerial vehicles are flown to a destination with a camera installed therein, so that the destination can be photographed without requiring a person to visit the destination.

[Non-patent Literature 1] “Parrot BEBOP DRONE”/[online], [searched on Apr. 30, 2015]/ Internet CURL: http://www.parrot.com/jp/products/bebop-drone/>

### SUMMARY

According to an aspect, of an embodiment, an information processing device includes a memory and a processor. The memory stores a content, in association with positional information, the content being to be displayed in a superimposed manner on an AR display terminal, the processor executes a process including: receiving, from a terminal device capable of sending a signal for setting a target position of an unmanned aerial vehicle, specification of any one of contents stored in the memory and outputting positional information corresponding to a content specified in the received specification to the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an exemplary system configuration;

FIG. 2 is a diagram that schematically illustrates a functional configuration of a drone;

FIG. 3 is a diagram that schematically illustrates a functional configuration of an AR server;

FIG. 4 is a diagram illustrating an exemplary hierarchical structure of contents;

FIG. 5 is a diagram illustrating an exemplary data configuration of a scenario management table;

FIG. 6 is a diagram illustrating an exemplary data structure of a scene management table;

FIG. 7 is a diagram illustrating an exemplary data configuration of a content management table;

FIGS. 8A and 8B are diagrams illustrating an example of a destination specification screen;

FIG. 9 is a diagram that schematically illustrates a functional configuration of a terminal device;

FIG. 10A is a diagram that schematically illustrates an example of a flight to a destination;

FIG. 10B is a diagram that schematically illustrates an example of a flight to destinations;

FIG. 11 is a diagram that schematically illustrates an example of a flight to a destination;

FIG. 12 is a flowchart for explaining an exemplary sequence of operations performed during information processing;

FIG. 13 is a flowchart for explaining an exemplary sequence of operations performed during a setting operation;

FIG. 14 is a flowchart for explaining an exemplary sequence of operations performed during a display control operation;

FIG. 15 is a diagram that schematically illustrates a functional configuration of the AR server according to a second embodiment;

FIG. 16 is a diagram illustrating an exemplary data configuration of a content management table according to the second embodiment;

FIG. 17 is a diagram that schematically illustrates an example of calculating the position of the target object for inspection;

FIG. 18 is a flowchart for explaining an exemplary sequence of operations performed during the information processing according to the second embodiment;

FIG. 19A is a diagram illustrating an exemplary computer that executes an information processing program; and

FIG. 19B is a diagram illustrating an exemplary computer that executes a setting/display control program.

### DESCRIPTION OF EMBODIMENTS

In order to make an unmanned aerial vehicle to take an autonomous flight, the destination needs to be set in the form of positional information, and the setting requires time and efforts.

Preferred embodiments of the present invention will be explained with reference to accompanying drawings. However, the present invention is not limited by the embodiments described herein. Moreover, the embodiments can be appropriately combined without causing contradiction in the processing details.

### First Embodiment

### System Configuration

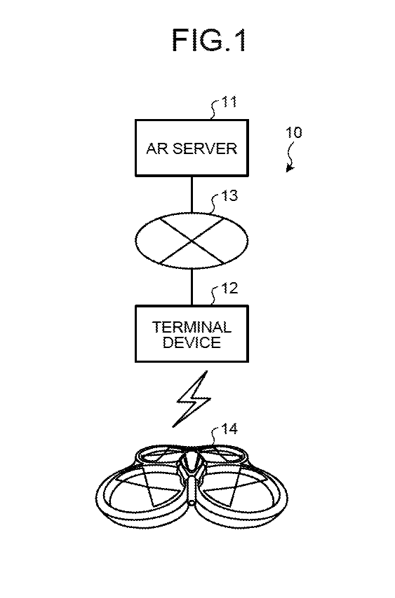

Firstly, the explanation is given about an example of a delivery system that delivers information. FIG. 1 is a diagram for explaining an exemplary system configuration. A system 10 represents an augmented reality (AR) system that provides an augmented reality. The system 10 includes an AR server 11 and a terminal device 12. The AR server 11 and the terminal device 12 are connected in a communicable manner to a network 13. As far as the network 13 is concerned; regardless of whether wired or wireless, it is possible to implement an arbitrary type of network such as mobile communication using a cellular phone, the Internet, a local area network (LAN, or a virtual private network (VPN).

The AR server 11 provides an augmented reality. The AR server 11 is, for example, a computer such as a personal computer or a server computer. Herein, the AR server 11 can be implemented using a single computer or using a plurality of computers. In the first embodiment, the explanation is given for an example in which the AR server 11 is implemented using a single computer. In the first embodiment, the AR server 11 corresponds to an information processing device.

The terminal device 12 displays an augmented reality. For example, the terminal device 12 is an information processing device such as a smartphone or a tablet terminal carried by a user of the augmented reality or a personal computer. In the example illustrated in FIG. 1, although a single terminal device 12 is illustrated, the number of terminal devices 12 can be set in an arbitrary manner. In the first embodiment, the AR server 11 corresponds to an AR display terminal and a terminal device. Meanwhile, the AR display terminal can be disposed separately from the terminal device 12 functioning as a terminal device. In the first embodiment, the explanation is given for an example in which the AR server 11 functions as an AR display device as well as a terminal device.

In the system 10, the AR server 11 provides an augmented reality to the terminal device 12. For example, in the system 10, when a camera of the terminal device 12 captures a predetermined target for recognition, a superimposed image is displayed in which the augmented reality is superimposed on the image that is taken. For example, a user carries the terminal device 12 and takes an image of a predetermined target for recognition using the camera of the terminal device 12. Then, the terminal device 12 identifies the current, position and the features of the image that is taken, and sends the current position and the image feature to the AR server 11. The image feature can be, for example, an AR marker or a quick response (QR) code serving as a reference sign for specifying the display position of an augmented reality. Alternatively, the image feature can be, for example, the feature of an object, such as an object of a particular shape or a particular pattern, captured in the image.

In the first embodiment, the explanation is given for an example in which the system 10 supports a factory inspection task using an augmented reality. For example, in a factory, AR markers are placed on the target for inspection or around the target for inspection. Each AR marker has a unique image stored therein. For example, in an AR marker, an image obtained by encoding a unique AR content ID serving as identification information is recorded. In the AR server 11, in a corresponding manner to the AR content IDs of the AR markers, information is stored regarding the contents to be displayed in a superimposed manner as an augmented reality on the target for inspection having the AR markers placed thereon. For example, in the AR server 11, contents are stored that, indicate the following precautions to be taken during the inspection: the details and points to be inspected, the previous inspection result, and the inspection procedure. Moreover, in the AR server 11, in a corresponding manner to the AR contents of the AR markers, positional information of the positions of the AR markers is stored. The worker responsible for the inspection goes to the target object for inspection while carrying the terminal device 12; and takes an image of the AR markers, which are placed on the target object or around the target object, using the terminal device 12. Then, the terminal device 12 recognizes the AR contents of the AR markers from the image that is taken, and sends the AR content IDs of the AR markers to the AR server 11. Subsequently, the AR server 11 reads the contents corresponding to the AR content IDs received from the terminal device 12, and sends the contents to the terminal device 12. Then, the terminal device 12 displays a superimposed image in which the contents received from the AR server 11 are superimposed on the image that is taken. As a result, for example, on the terminal device 12, contents indicating the precautions to be taken during the inspection, such as the details or points to be inspected, the previous inspection result, and the inspection procedure, are displayed in a superimposed manner on the target object for inspection in the image that is taken. As a result, the worker responsible for the inspection can refer to the displayed contents and understand the precautions to be taken during the inspection. Hence, the inspection can be performed in an efficient manner.

In the first embodiment, a destination of an unmanned aerial vehicle is set with the aid of the system 10. As illustrated in FIG. 1, the system 10 includes a drone 14.

The drone 14 is an unmanned aerial vehicle capable of flying in an unmanned state. The drone 14 illustrated in FIG. 1 has four propellers, and flies when the propellers are rotated. Meanwhile, in the example illustrated in FIG. 1, although the drone 14 is a multicopter having four propellers, the number of propellers is not limited to four.

### Drone Configuration

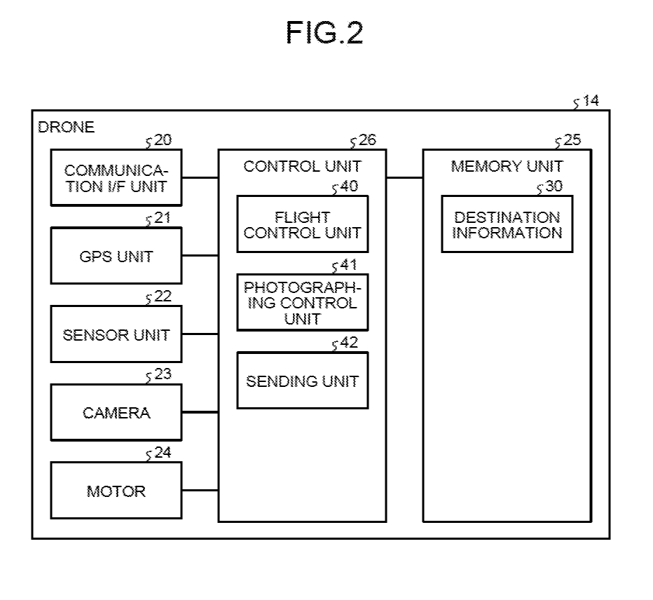

Given below is the explanation of a configuration of each device. Firstly, the explanation is given about a configuration of the drone 14. FIG. 2 is a diagram that schematically illustrates a functional configuration of the drone. The drone 14 includes a communication interface (I/F) unit 20, a GPS unit 21, a sensor unit 22, a camera 23, motors 24, a memory unit 25, and a control unit 26. Meanwhile, the drone 14 can also include devices other than the devices mentioned above.

The communication I/F unit 20 represents an interface for performing communication control with other devices. The communication I/F unit 20 sends a variety of information to and receives a variety of information from other devices via wireless communication. For example, the communication I/F unit 20 corresponds to an ad hoc mode of a wireless LAN, and sends a variety of information to and receives a variety of information from the terminal device 12 via wireless communication in the ad hoc mode. For example, the communication I/F unit 20 receives the positional information of a destination and a variety of operation information from the terminal device 12, Moreover, the communication I/F unit 20 sends image data and positional information of a taken image and sends orientation information to the terminal device 12. Meanwhile, alternatively, the communication I/F unit 20 can send a variety of information or receive a variety of information with another device via an access point. Still alternatively, the communication I/F unit 20 can send a variety of information to or receive a variety of information from another device via a mobile communication network such as a cellular phone network.

The GPS unit 21 represents a position measuring unit that receives radio waves from a plurality of GPS satellites, determines the distance to each GPS satellite, and measures the current position. For example, the GPS unit 21 generates positional information indicating the position in the geodetic system of latitude, longitude, and height.

The sensor unit 22 represents a sensor for detecting the state such as the orientation of the drone 14. Examples of the sensor unit 22 include a 6-axis acceleration sensor, a gyro sensor, and an orientation sensor. For example, the sensor unit 22 outputs orientation information indicating the orientation and the position of the drone 14.

The camera 23 represents an imaging device that takes images using an imaging element such as a charge coupled device (CCD) or a complementary metal oxide semiconductor (CMOS). The camera 23 is installed at a predetermined position of the housing of the drone 14 so that the outside of the drone 14 can be captured. For example, the camera 23 is installed in the lower part of the drone 14 so that the downward direction can be captured. The camera 23 takes images under the control of the control unit 26 and outputs image data of the taken images. Meanwhile, it is also possible to install a plurality of cameras 23. For example, two cameras 23 can be installed

so that the horizontal direction and the downward direction can be captured. Herein, the camera 23 is installed at a predetermined position of the housing of the drone 14. Hence, when the sensor unit 22 identifies the orientation of the drone 14, the photographing direction of the camera 23 becomes identifiable.

The motors 24 represent power devices that rotary-drive the propellers. Herein, the motor 24 is individually installed for each propeller. Under the control of the control unit 26, the motors 24 rotate the propellers and fly the drone 14.

The memory unit 25 represents a memory device that is used to store a variety of information. For example, the memory unit 25 is a data rewritable semiconductor memory such as a random access memory (RAM), a flash memory, or a nonvolatile static random access memory (NVSRAM). Alternatively, the memory unit 25 can be a memory device such as a hard disk, a solid state drive (SSD), or an optical disk.

The memory unit 25 is used to store a control program and various computer programs executed by the control unit 26. Moreover, the memory unit 25 is used to store a variety of data used in the computer programs that are executed by the control unit 26. For example, the memory unit 25 is used to store destination information 30.

The destination information 30 represents data in which coordinate data of a destination position is stored. For example, in the destination information 30, a destination position is stored in the geodetic system of latitude, longitude, and height. In the destination information 30, it is also possible to store a plurality of destinations. For example, in the case in which the drone 14 is to be flown over a plurality of destinations, the destination information 30 has a plurality of destinations stored therein. Alternatively, in the case of flying over a plurality of destinations, the destination information 30 can have the destinations stored therein along with the passing sequence. Still alternatively, in the destination information 30, the destinations can be stored according to the passing sequence.

The control unit 26 represents a device for controlling the drone 14. As far as the control unit 26 is concerned, it is possible to use an electronic circuit such as a central processing unit (CPU) or a micro processing unit (MFU), or to use an integrated circuit such as an application specific integrated circuit (ASIC) or a field programmable gate array (FPGA). The control unit 26 includes an internal memory for storing computer programs in which various sequences of operations are defined and for storing control data; and performs various operations using the stored data. The control unit 26 functions as various operating units as a result of executing a variety of computer programs. For example, the control unit 26 includes a flight control unit 40, a photographing control unit 41, and a sending unit 42.

The flight control unit 40 performs flight control of the drone 14. For example, the flight control unit 40 controls the rotation of the motors 24 according to the state of the drone 14, such as according to the orientation and the position indicated by the orientation information detected by the sensor unit 22; and performs control to stabilize the flight condition of the drone 14. Moreover, the flight control unit 40 compares the current position measured by the GPS unit 21 with the destination position stored in the destination information 30; identifies the direction of the destination; controls the rotation of the motors 24; and performs control to fly the drone 14 in the identified direction.

The photographing control unit 41 controls the camera 23 to take images. For example, the photographing control unit 41 uses the camera 23 to shoot videos at a predetermined framerate.

The sending unit 42 sends a variety of information. For example, the sending unit 42 sends image data obtained by the camera 23 to the terminal device 12. Moreover, the sending unit. 42 sends the positional information, which is measured by the GPS unit 21, and the orientation information, which is detected by the sensor unit 22, to the terminal device 12.

### Configuration of AR Server

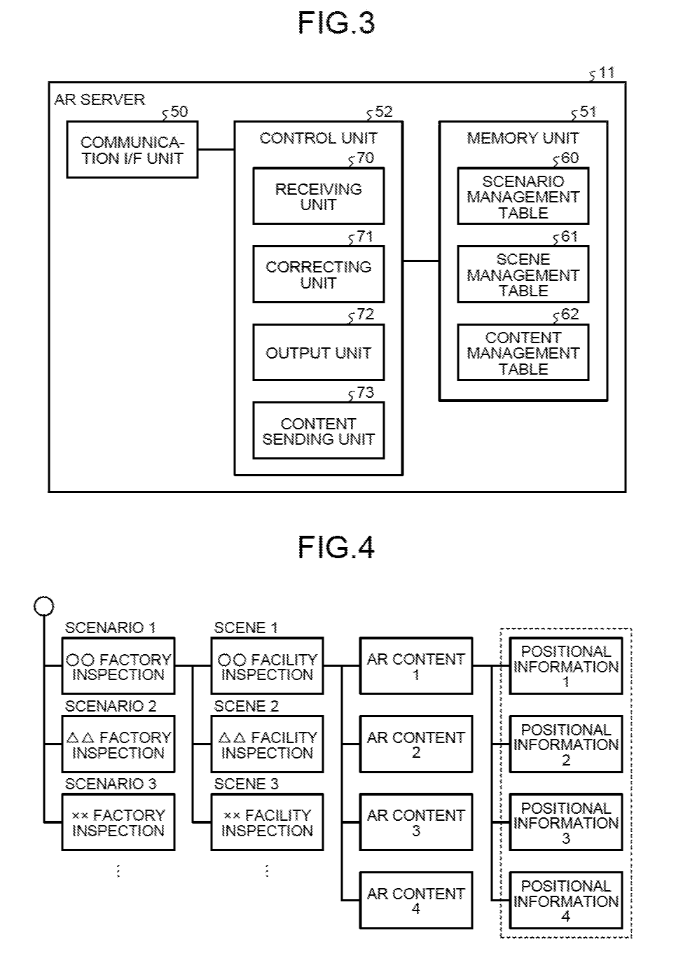

Given below is the explanation of a configuration of the AR server 11. FIG. 3 is a diagram that schematically illustrates a functional configuration of the AR server. As illustrated in FIG. 3, the AR server 11 includes a communication I/F unit 50, a memory unit 51, and a control unit 52. Meanwhile, the AR server 11 can also include devices other than the devices mentioned above.

The communication I/F unit 50 represents an interface for performing communication control with other devices. For example, the communication I/F unit 50 sends a variety of information to and receives a variety of information from the terminal device 12 via the network 13. For example, the communication I/F unit 50 receives positional information from the terminal device 12. Moreover, when contents corresponding to the received information are available, the communication I/F unit 50 sends information related to the contents to the terminal device 12.

The memory unit 51 is a memory device such as a hard disk, an SSD, or an optical disk. Alternatively, the memory unit 51 can be a data rewritable semiconductor memory such as a RAM, a flash memory, or an NVSRAM.

The memory unit 51 is used to store the operating system (OS) and various computer programs executed by the control unit 52. For example, the memory unit 51 is used to store computer programs that are used in performing various operations including information processing (described later). Moreover, the memory unit 51 is used to store a variety of data used in the computer programs executed by the control unit 52. For example, the memory unit 51 is used to store a scenario management table 60, a scene management table 61, and a content management table 62.

In the first embodiment, contents are divided into one or more hierarchies before being stored in the memory unit 51. FIG. 4 is a diagram illustrating an exemplary hierarchical structure of contents. In FIG. 4 is illustrated an example in which contents related to the task of inspecting factories are hierarchized into “scenario”, “scene”, and “contents”. In the first embodiment, a scenario is set for each target factory for inspection. In the example illustrated in FIG. 4, scenarios are set as follows: “OO factory inspection” as scenario 1; “ΔΔ factory inspection” as scenario 2; and “xx factory inspection” as scenario 3. A scenario has one or more scenes set under it. In the first embodiment, a scene is set for each target facility for inspection. In the example illustrated in FIG. 4, under the scenario “OO factory inspection”, following scenes are set: “OO facility inspection” as scene 1; “ΔΔ facility inspection” as scene 2; and “xx facility inspection” as scene 3. A scene has one or more contents set under it. In the first embodiment, a content is set for each target object for inspection. In the example illustrated in FIG. 4, under the scene “OO facility inspection”, following contents are set: AR content 1, AR content 2, AR content 3, and AR content 4. Each of the contents has positional information associated thereto that indicates the position of the target, object for inspection. In the example illustrated in FIG. 4, the AR content 1 has positional information 1 associated thereto, the AR content 2 has positional information 2 associated thereto, the AR content 3 has positional information 3 associated thereto, and the AR content 4 has positional information 4 associated thereto.

Returning to the explanation with reference to FIG. 3, the scenario management table 60 represents data in which information related to scenarios is stored. The scenario management table 60 is used to store registered scenarios. For example, in the scenario management table 60, for each target factory for inspection, the inspection of the factory is registered as a scenario.

FIG. 5 is a diagram illustrating an exemplary data configuration of the scenario management table. As illustrated in FIG. 5, the scenario management table 60 includes “scenario ID” and “scenario name” as items. The item “scenario ID” represents an area in which identification information of scenarios is stored. Each scenario is assigned with a unique scenario ID that serves as the identification information enabling identification of the concerned scenario. Thus, in the item “scenario ID”, the scenario IDs assigned to the scenarios are stored. The item “scenario name” represents an area in which the names of scenarios are stored.

In the example illustrated in FIG. 5, a scenario ID “1” indicates that “OO factory inspect ion” is the name of the corresponding scenario; scenario ID “2” indicates that. “ΔΔ factory inspection” is the name of the corresponding scenario; and a scenario ID indicates that, “xx factory inspection” is the name of the corresponding scenario.

Returning to the explanation with reference to FIG. 3, the scene management table 61 represents a table in which information related to scenes is stored. In the scene management table 61, the scenes that are registered in a corresponding manner to the scenarios are stored. For example, in the scene management table 61, the target facilities for inspection in a target factory for inspection are registered as the scenes.

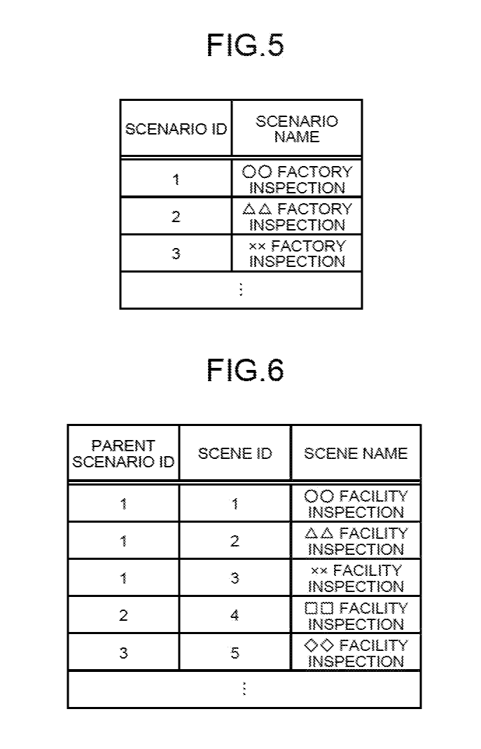

FIG. 6 is a diagram illustrating an exemplary data structure of the scene management table. As illustrated in FIG. 6, the scene management table 61 includes “parent scenario ID”, “scene ID”, and “scene name” as items. The item “parent scenario ID” represents an area in which scenario IDs of such scenarios are stored which have the concerned scenes associated thereto. The item “scene ID” represents an area in which identification information of scenes is stored. Each scene is assigned with a unique scene ID that serves as identification information enabling identification of the concerned scene. Thus, in the item “scene ID”, the scene IDs assigned to the scenes are stored. The item “scene name” represents an area in which the names of scenes are stored.

In the example illustrated in FIG. 6, a scene ID “1” indicates that “OO facility inspection” is the name of the corresponding scene which is associated to the scenario having the scenario ID “1”. A scene ID “2” indicates that “ΔΔ facility inspection” is the name of the corresponding scene which is associated to the scenario having the scenario ID “1”. A scene ID “3” indicates that “xx facility inspection” is the name of the corresponding scene which is associated to the scenario having the scenario ID “I”. A scene ID “4” indicates that “□□ facility inspection” is the name of the corresponding scene which is associated to the scenario having the scenario ID “2”. A scene ID “5” indicates that “OO facility inspection” is the name of the corresponding scene which is associated to the scenario having the scenario ID “3”.

Returning to the explanation with reference to FIG. 3, the content management table 62 represents data in which information related to contents is stored. For example, in the content management table 62, following information is registered for each target object for inspection: the positional information of the target object; the content to be displayed; and the display format.

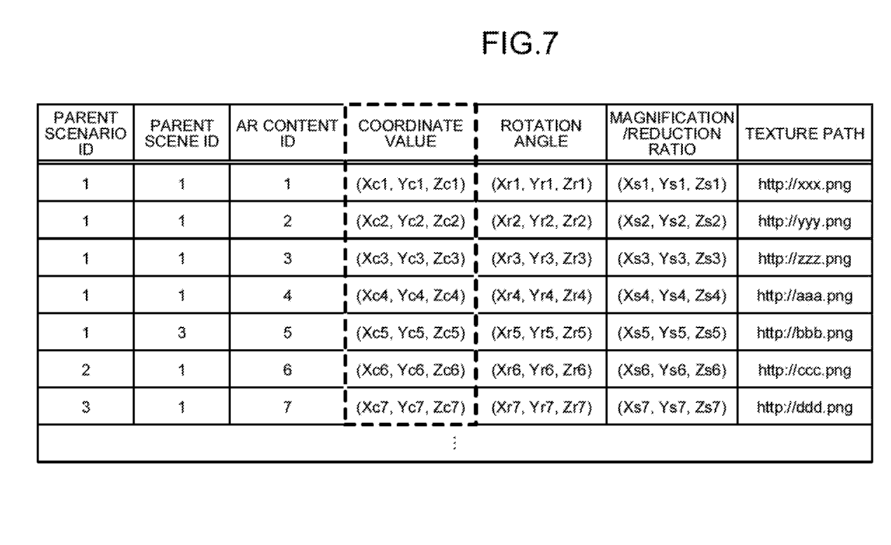

FIG. 7 is a diagram illustrating an exemplary data configuration of the content management, table. As illustrated in FIG. 7, the content management table 62 includes “parent scenario ID”, “parent, scene ID”, “AR content ID”, “coordinate value”, “rotation angle”, “magnification/reduction rate”, and “texture path” as items. The item “parent scenario ID” represents an area in which scenario IDs of such scenarios are stored which have the concerned contents associated thereto. The item “parent scene ID” represents an area in which scene IDs of such scenes are stored which have the concerned contents associated thereto. The item “AR content ID” represents an area in which identification information of contents is stored. Each content is assigned with a unique AR content ID that serves as identification information enabling identification of the concerned content. Thus, in the item “AR content ID”, the AR content IDs assigned to the contents are stored. The item “coordinate value” represents an area in which positional information indicating the display positions for displaying contents is stored. Herein, the positional information is used in controlling the display positions of the contents that are displayed in a superimposed manner on the terminal device 12. In the item “coordinate value”, positional information indicating the positions of the target objects for inspection or indicating the positions of the AR markers corresponding to the target objects for inspection are stored as the display positions of the contents. In the present embodiment, in the item “coordinate value”, positional information indicating the positions of the target objects for inspection or indicating the positions of the AR markers corresponding to the target objects for inspection are stored in the geodetic system of latitude, longitude, and height. The item “rotation angle” represents an area in which the angles of rotation at the time of displaying the contents are stored. The item “magnification/reduction ratio” represents an area in which the ratios of magnification or reduction at the time of displaying the contents are stored. The item “texture path” represents an area in which information related to the storage destinations of the contents to be displayed are stored.

In the example illustrated in FIG. 7, it is illustrated that the content having the AR content ID “1” is associated with the scenario having the parent scenario ID and is associated with the scene having the parent scene ID “1”. Moreover, it is illustrated that the content having the AR content ID “1” is displayed at the position having a latitude Xc1, a longitude Yc1, and a height Zc1. That is, it is illustrated that the target object for inspection is positioned at the latitude Xc1, the longitude Yc1, and the height Zc1. Furthermore, it is illustrated that the content having the AR content ID is to be stored at a storage destination “http://xxx.png” and is to be displayed with a rotation angle (Xr1, Yr1, Zr1) and with a magnification/reduction ratio (Xs1, Ys1, Zs1).

Returning to the explanation with reference to FIG. 3, the control unit 52 is a device that controls the AR server 11. As far as the control unit 52 is concerned, it is possible to use an electronic device such as a CPU or an MPU, or to use an integrated circuit such as an ASIC or an FPGA, The control unit 52 includes an internal memory for storing computer programs in which various sequences of operations are defined and for storing control data; and performs various operations using the stored data. The control unit 52 functions as various operating units as a result of executing a variety of computer programs. For example, the control unit 52 includes a receiving unit 70, a correcting unit 71, an output unit 72, and a content sending unit 73.

The receiving unit 70 receives various operations. For example, the receiving unit 70 sends image information of various operation screens to the terminal device 12 so that, various operation screens are displayed on the terminal device 12, and then receives various operations from the operation screens. For example, in the case of supporting a factory inspection task using an augmented reality, the receiving unit 70 displays an inspection specification screen that enables specification of the scenario or the scene to be inspected, and then receives specification of a scenario or a scene from the inspection specification screen. Moreover, in the case of supporting the setting of a destination of the drone 14, the receiving unit displays a destination specification screen that enables specification of the content settable as a destination of the drone 14, and receives specification of the destination of the drone 14 from the destination specification screen. In the first embodiment, it is assumed that the destinations of the drone 14 are specifiable using a scenario or a scene. When a scenario or a scene is specified, the positions indicated by the positional information of the contents included under the specified scenario or scene are set as the destinations, and a flight route passing over each destination is set.

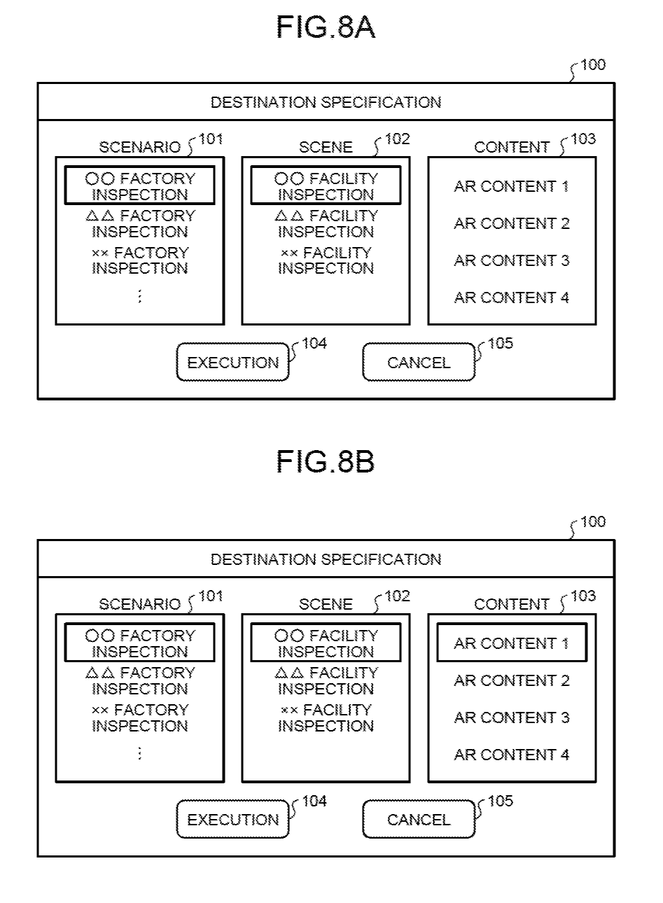

FIGS. 8A and 8B are diagrams illustrating an example of the destination specification screen. As illustrated in FIGS. 8A and 8B, a destination specification screen 100 includes a scenario selecting portion 101, a scene selecting portion 102, a content selecting portion 103, an execution button 104, and a cancel button 105.

In the scenario selecting portion 101, the names of all scenarios stored in the scenario management table 60 are displayed so that any one of the scenarios can be selected. When a scenario is selected in the scenario selecting portion 101, the scenes under the selected scenario are displayed on the scene selecting portion 102. In FIGS. 8A and 8B is illustrated an example in which the scenario “OO factory inspection” is selected in the scenario selecting portion 101. In the scene selecting portion 102, the scenes “OO facility inspection”, “ΔΔ facility inspection”, and “xx facility inspection” are displayed as the scenes under the scenario “OO factory inspection”. In the scene selecting portion 102, any one of those scenes can be selected. When a scene is selected in the scene selecting portion 102, the contents under the selected scene are displayed in the content selecting portion 103. In FIGS. 8A and 8B is illustrated an example in which the scene “OO facility inspection” is selected in the scene selecting portion 102. Thus, in the content selecting portion 103, the contents “AR content 1”, “AR content 2”, “AR content 3”, and “AR content 4” are displayed. In the content, selecting portion 103, any one of those contents can be selected. In FIG. 8B is illustrated an example in which the content “AR content 1” is selected in the content selecting portion 103.

In the case of specifying the destination using a scenario or a scene, the execution button 104 is pressed once a scenario or a scene is specified. For example, once “OO facility inspection” is specified as illustrated in FIG. 8A, the execution button 104 is pressed. Meanwhile, in the case of specifying the destination using a content, the execution button 104 is pressed once a content is specified as illustrated in FIG. 8B.

The correcting unit 71 corrects the positional information of the destination. For example, when the receiving unit 70 receives specification of a destination of the drone 14 from the destination specification screen 100, the correcting unit 71 reads the positional information corresponding to the specified content from the content management table 62. Meanwhile, when the destination is specified using a scenario or a scene, the correcting unit 71 reads, from the content management table 62, the positional information corresponding to each content under the scenario or the scene specified as the destination.

The correcting unit 71 performs correction by adding predetermined height information to height-information of the coordinate data indicated by the positional information that is read. For example, the correcting unit 71 corrects the read positional information into positional information in which a predetermined value is added to the height value included in the positional information. That is, the correcting unit 71 corrects the height component of the coordinate data indicated by the positional information to a higher value by a predetermined height. Herein, the predetermined height is set to 50 m, for example. The predetermined height can be set from outside. For example, the predetermined height can be specified from an operation screen. Then, the correcting unit 71 sets, as the positional information of the destination, coordinate data obtained by adding predetermined height information to the height information of the coordinate data.

The output unit 72 outputs the positional information that is set. as the destination of the drone 14. For example, when the receiving unit 70 receives

specification of a destination of the drone 14 from the destination specification screen 100; the output unit 72 sends the positional information, in which the height information is corrected by the correcting unit 71, as the positional information corresponding to the destination to the terminal device 12. In the first embodiment, the terminal device 12 sets the received positional information as the destination of the drone 14.

The content sending unit 73 sends contents. For example, the content sending unit 73 sends, to the terminal device 12, the content having the AR content ID received from the terminal device 12 or corresponding to the positional information received from the terminal device 12. For example, when an AR content ID is received, the content sending unit 73 searches the contents under the specified scenario or the specified scene, which is specified in the inspection specification screen, for the content having the received AR content ID. As a result of performing the search, if the content having the received AR content ID is present, then the content sending unit 73 reads the content having the received AR content ID from the corresponding storage destination, and sends the read content along with the corresponding rotation angle and the corresponding magnification/reduction ratio to the terminal device 12. Meanwhile, when positional information is received, the content sending unit 73 compares the positional information with the positional information of each content present under the scenario or the scene specified in the inspection specification screen; and determines whether the received positional information corresponds to the positional information of any content. If the position indicated by the received positional information falls within a predetermined permissible range from the positional information of any content, then the content sending unit 73 determines that, the received positional information corresponds to the positional information of that content. Herein, the permissible range is determined, for example, according to the amount of correction performed by the correcting unit 71. For example, when the correcting unit 71 corrects the height by increasing it by 50 m, the permissible range is set up to a value lower by 50 m. Meanwhile, the permissible range can be set by taking into account, the positional error. For example, the permissible range can be set as a range obtained by adding the GPS error and the amount of correction of the position. Meanwhile, the permissible range can be made settable from outside. As a result of comparison, if the position indicated by the positional information received from the terminal device 12 corresponds to the position indicated by the positional information of any one of the contents, then the content sending unit 73 reads the concerned content from the corresponding storage destination and sends the read content along with the corresponding rotation angle and the corresponding magnification/reduction ratio to the terminal device 12.

### Configuration of Terminal Device

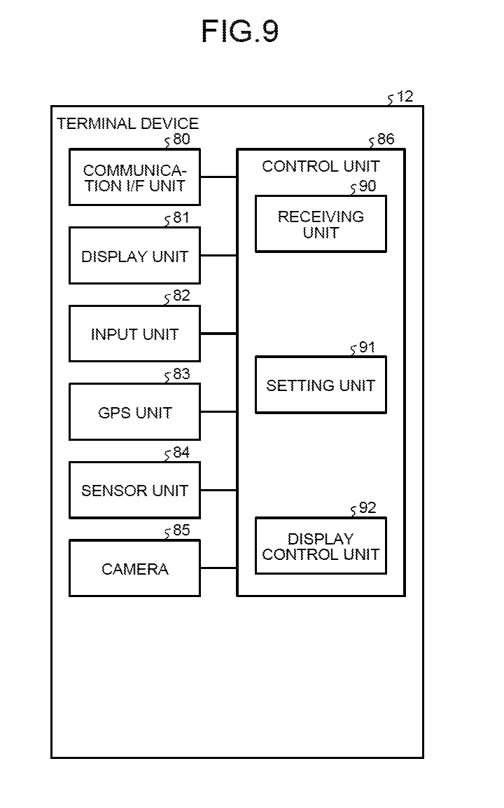

Given below is the explanation of a configuration of the terminal device 12. FIG. 9 is a diagram that schematically illustrates a functional configuration of the terminal device. As illustrated in FIG. 9, the terminal device 12 includes a communication I/F unit 80, a display unit 81, an input unit 82, a GPS unit 83, a sensor unit 84, a camera 85, and a control unit 86. Meanwhile, the terminal device 12 can also include devices other than the devices mentioned above.

The communication I/F unit 80 represents an interface for performing communication control with other devices. For example, the communication I/F unit 80 sends a variety of information to and receives a variety of information from the AR server 11 via the network 13. For example, the communication I/F unit 80 receives image information of operation screens from the AR server 11. Moreover, the communication I/F unit 80 sends operation information received from an operation screen and positional information to the AR server 11.

Moreover, for example, the communication I/F unit 80 sends a variety of information to and receives a variety of information from the drone 14. For example, the communication I/F unit 80 sends the positional information of the destinations and a variety of operation information to the drone 14, Besides, the communication I/F unit 80 receives image data of the images taken by the drone 14 and receives the positional information of the drone 14. Meanwhile, in the first embodiment, the explanation is given for an example in which the wireless communication with the AR server 11 and the drone 14 is performed using the communication I/F unit 80. Alternatively, it is also possible to have separate communicating units for performing wireless communication with the AR server 11 and the drone 14.

The display unit 81 represents a display device for displaying a variety of information. Examples of the display unit 81 include display devices such as a liquid crystal display (LCD) and a cathode ray tube (CRT). Thus, the display unit 81 is used to display a variety of information. For example, the display unit 81 displays various screens such as operation screens based on image information of operation screens that is received from the AR server 11.

The input unit 82 represents an input device for receiving input of a variety of information. Examples of the input unit 82 include various buttons installed on the terminal device 12, and an input device such as a transmissive touch sensor installed on the display unit 81. Thus, the input unit 82 receives input of a variety of information. Herein, the input unit 82 receives an operation input from the user, and then inputs operation information indicating the received operation details to the control unit 86. Meanwhile, in the example illustrated in FIG. 9, since a functional configuration is illustrated, the display unit 81 and the input unit 82 are illustrated separately. However, alternatively, a device such as a touch-sensitive panel can be configured to include the display unit 81 and the input unit 82 in an integrated manner. Meanwhile, the input unit 82 can be an input device such as a mouse or a keyboard that receives input of operations.

The GPS unit 83 represents a position measuring unit that receives radio waves from a plurality of GPS satellites, determines the distance to each GPS satellite, and measures the current position. For example, the GPS unit 83 generates positional information indicating the position in the geodetic system of latitude, longitude, and height. In the first embodiment, the GPS unit 83 corresponds to an obtaining unit.

The sensor unit 84 represents a sensor for detecting the state such as the orientation of the terminal device 12. Examples of the sensor unit 84 include a 6-axis acceleration sensor, a gyro sensor, and an orientation sensor. For example, the sensor unit 84 outputs orientation information indicating the orientation and the position of the terminal device 12.

The camera 85 represents an imaging device that takes images using an imaging element such as a CCD or a CMOS. The camera 85 is installed at a predetermined position of the housing of the terminal device 12 so that the outside of the terminal device 12 can be captured. The camera 85 takes images under the control of the control unit 86 and outputs image data of the taken image. Herein, the camera 85 is installed at a predetermined position of the housing of the terminal device 12. Hence, when the sensor unit 84 identifies the orientation of the terminal device 12, the photographing direction of the camera 85 becomes identifiable.

The control unit 86 is a device that controls the terminal device 12. As far as the control unit 86 is concerned, it is possible to use an electronic device such as a CPU or an MPU, or to use an integrated circuit, such as an ASIC or an FPGA. The control unit 86 includes an internal memory for storing computer programs in which various sequences of operations are defined and for storing control data; and performs various operations using the stored data. The control unit 86 functions as various operating units as a result of executing a variety of computer programs. For example, the control unit 86 includes a receiving unit 90, a setting unit 91, and a display control unit 92.

The receiving unit 90 receives various operations. For example, the receiving unit 90 displays various operation screens on the display unit 81 and receives a variety of operation input. For example, based on the image information of an operation screen received from the AR server 11, the receiving unit 90 displays an operation screen and receives operations with respect to that operation screen. For example, the receiving unit 90 displays the inspection specification screen or the destination specification screen 100, and receives specification of a scenario or a scene to be inspected or receives specification of a destination. Then, the receiving unit 90 sends operation information with respect to the operation screen to the AR server 11. For example, in the case of specifying a destination, the receiving unit 90 displays the destination specification screen 100 illustrated in FIGS. 8A and 8B, and sends operation information with respect to the destination specification screen 100 to the AR server 11. When a destination is specified in the destination specification screen 100, the AR server 11 sends positional information corresponding to the specified destination to the terminal device 12.

Moreover, for example, the receiving unit 90 displays an operation screen that enables issuing an instruction to take an image, and receives an instruction operation regarding taking an image. Moreover, for example, the receiving unit 90 displays an operation screen that enables issuing an instruction to switch to the image taken by the drone 14, and receives a switch operation regarding the taken image.

The setting unit 91 performs various settings with respect to the drone 14. For example, the setting unit 91 sets, in the destination information 30 of the drone 14, the positional information corresponding to the destination received from the AR server 11.

The display control unit 92 performs display control of a variety of information with respect to the display unit 81. For example, the display control unit 92 performs control to display the images taken by the camera 85 or the drone 14. For example, when an instruction for displaying images taken by the camera 85 is issued from an operation screen, the display control unit 92 shoots a video at a predetermined framerate using the camera 85. The display control unit 92 performs image recognition regarding whether an AR marker is included in each taken image. When an AR marker is not recognized in the taken image, the display control unit 92 displays the taken image on the display unit 81. On the other hand, when an AR marker is recognized in the taken image, the display control unit 92 recognizes the AR content ID of the AR marker and sends it to the AR server 11.

The AR server 11 sends, to the terminal device 12, the content having the AR content ID received from the terminal device 12, along with the rotation angle and the magnification/reduction ratio of the concerned content.

The display control unit 92 generates a superimposed image that is obtained by superimposing the content, which is received from the AR server 11, with the received rotation angle and the magnification/reduction ratio on the image taken by the camera 85; and displays the superimposed image on the display unit 81. As a result, for example, at the time when the worker responsible for the inspection performs inspection while carrying the terminal device 12, when an AR marker is photographed using the terminal device 12, a superimposed image in which the corresponding content is superimposed gets displayed. Hence, the worker responsible for the inspection can refer to the superimposed content and understand the precautions to be taken during the inspection, thereby enabling him or her to perform inspection in an efficient manner.

During the inspection of a site that is set as a destination of the drone 14, when the drone 14 is present over the site, the display control unit 92 displays on the display unit 81 a superimposed image in which a predetermined mark indicating the drone is superimposed on the image taken by the camera 85. For example, the display control unit 92 determines that the positional information received from the drone 14 corresponds to the positional information of the drone 14 as set by the setting unit 91. When the positional information received from the drone 14 indicates a position within a predetermined permissible range from the positional information of the destination, the display control unit 92 determines that the received positional information corresponds to the positional information of the destination. When the positional information received from the drone 14 corresponds to the positional information of the destination, the display control unit 92 determines that the photographing area of the camera 85 includes the position of the drone 14. For example, from the positional information measured by the GPS unit 83 and the orientation information detected by the sensor unit 84, the display control unit 92 identifies the current position of the terminal device 12 and identifies the photographing direction of the camera 85. Once the current position of the terminal device 12 and the photographing direction of the camera 85 are identified, the photographing area can also be identified from the angle of the camera 85. When the photographing area of the camera 85 includes the site indicated by the positional information received from the drone 14, the display control unit 92 performs display by superimposing a predetermined mark on that point, in the image taken by the camera 85 which corresponds to the position of the drone 14. As a result, the worker responsible for the inspection can understand that the drone 14 is present over the site. Meanwhile, the positional information of the drone 14 can also be sent in real time to the terminal device 12. In that case, even if the drone 14 is in motion, when the position of the drone 14 is included in the photographing range of the camera 85 of the terminal device 12, a mark representing the drone 14 can be displayed in a superimposed manner on the display unit 81 of the terminal device 12. In this way, as a result of displaying a predetermined mark in a superimposed manner on the point corresponding to the position of the drone 14, even if the

background scenery of the drone 14 is difficult to see, the presence of the drone can be recognized in a reliable manner.

The receiving unit 90 receives a movement operation with respect to the predetermined mark representing the drone 14 displayed on the display unit 81. The setting unit 91 updates the destination information of the drone 14 according to the movement operation received by the receiving unit 90. For example, when a movement operation is performed to move the predetermined mark, which represents the drone and which is displayed on the display unit 81, to the left side or the right side with a finger, the setting unit 91 updates the coordinate information of the drone 14 according to the movement operation. As a result of moving the mark displayed on the display unit 81, the operation of moving the actual drone 14 can be performed with ease.

Meanwhile, for example, when an instruction for displaying an image taken by the drone 14 is issued from the operation screen, the display control unit 92 displays, on the display unit 81, the taken image that is received from the drone 14. Moreover, the display control unit 92 sends the positional information, which is received from the drone 14, to the AR server 11.

When a content is available corresponding to the positional information received from the terminal device 12, the AR server 11 sends the concerned content along with the rotation angle and the magnification/reduction ratio of the content to the terminal device 12.

When the content is received from the AR server 11, the display control unit 92 generates a superimposed image that, is obtained by superimposing the content, which is received from the AR server 11, with the received rotation angle and the magnification/reduction ratio on the taken image; and displays the superimposed image on the display unit 81.

Given below is the explanation of a specific example. For example, in the case of performing inspection in a factory, in order to check the condition of the target object for inspection, the worker responsible for the inspection sets the positional information of the target, object for inspection as the destination of the drone 14 and then flies the drone 14. For example, the worker responsible for the inspection operates the terminal device 12 and specifies a scenario, a scene, or a content to be set as the destination from the destination specification screen 100. When a content is specified, the AR server 11 sends the positional information corresponding to the specified content to the terminal device 12. Then, the terminal device 12 sets the received positional information in the destination information 30 of the drone 14. With that, the drone 14 takes an autonomous flight to the destination represented by the position set in the destination information 30.

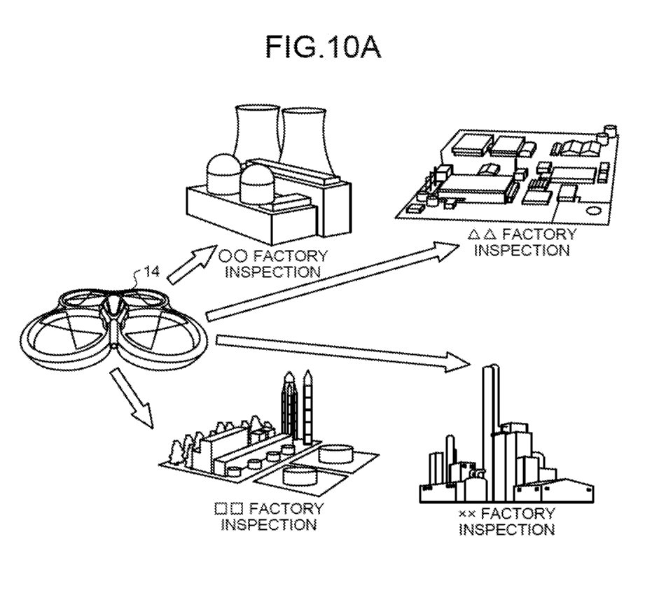

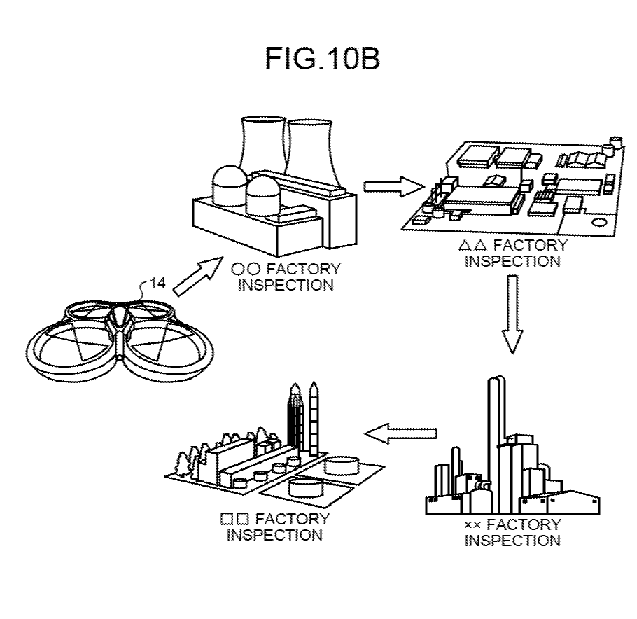

FIG. 10A is a diagram that, schematically illustrates an example of a flight to a destination. In FIG. 10A is illustrated an example in which a single set of positional information is set in the destination information 30. For example, when the positional information of either one of “OO factory”, “ΔΔ factory”, “□□ factory”, and “xx factory” is set as the destination, the drone 14 takes an autonomous flight to the destination factory.

FIG. 10B is a diagram that schematically illustrates an example of a flight to destinations. In FIG. 10B is illustrated an example in which the positional information of a plurality of destinations is set in the destination information 30. For example, when the positional information of “OO factory”, “ΔΔ factory”, “xx factory”, and “□□ factory” is set in that order as the destinations, the drone 14 takes an autonomous flight to make a round over the factories in order of “OO factory”, “ΔΔ factory”, “xx factory”, and “□□ factory”.

Meanwhile, the AR server 11 performs correction by adding predetermined height information to the height information of the coordinate data indicated by the positional information corresponding to the concerned content. That is, the destination of the drone 14 is not set at the setting position of the AR content but is set over the setting position of the AR content. With such a configuration, the inspection site at which the AR content is set can be aerially photographed from a single point, over the inspection site. Moreover, the drone 14 can be flown in a stable manner.

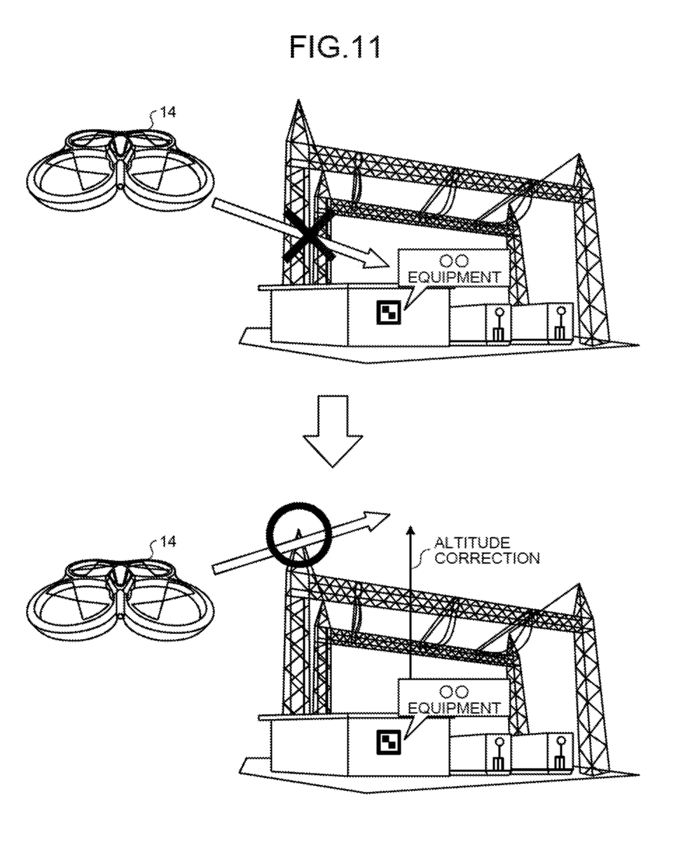

FIG. 11 is a diagram that schematically illustrates an example of a flight to a destination. In the example illustrated in FIG. 11, in the positional information corresponding to the concerned content, the positional information of the target, objet is stored. In that, case, when the positional information of the content is set as the positional information corresponding to the content, there are times when the buildings or the equipment in the vicinity of the target object become obstacles thereby not allowing a flight up to the position of the target object. In that regard, as a result of performing correction by adding predetermined height information to the height information of the coordinate data indicated by the positional information corresponding to the content, flying over the inspection site becomes possible.

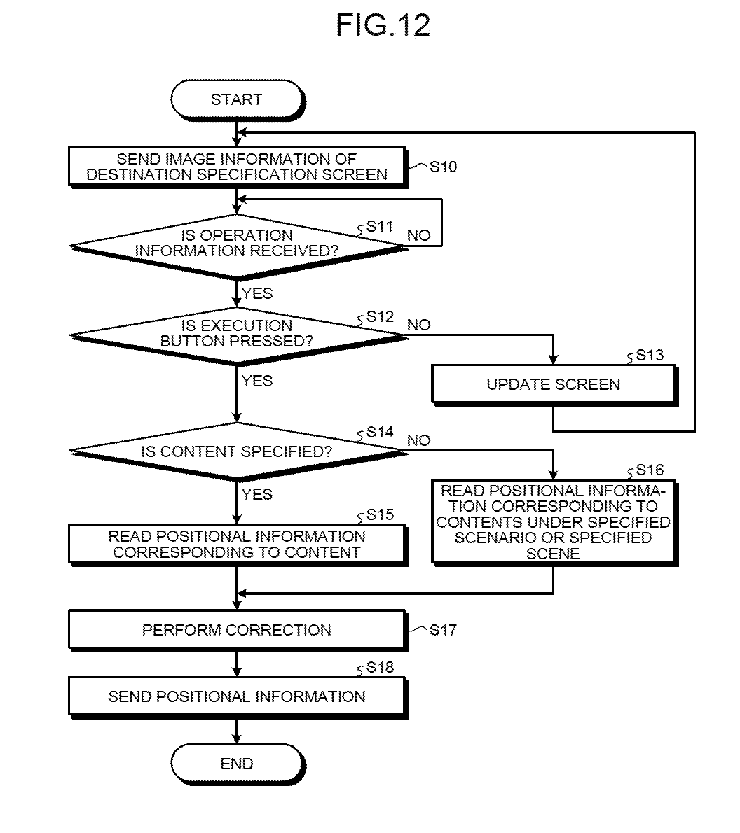

Given below is the explanation of various operations performed in the system 10 according to the first embodiment. Firstly, the explanation is given about a sequence of operations during the information processing performed by the AR server 11 to support setting of the destination of the drone 14. FIG. 12 is a flowchart for explaining an exemplary sequence of operations performed during the information processing. Herein, the information processing is performed at a predetermined timing such as the timing at which a predetermined operation for requesting the display of the destination specification screen 100 is performed via the terminal device 12.

As illustrated in FIG. 12, the receiving unit 70 sends the image information of the destination specification screen 100 to the terminal device 12 and displays the destination specification screen 100 on the terminal device (S10). The receiving unit 70 determines whether or not operation information is received from the terminal device 12 (S11). If operation information is not received (No at S11), the system control returns to S11 and the reception of operation information is awaited.

When operation information is received (Yes at S11), the receiving unit 70 determines whether or not the operation points to the pressing of the execution button 104 (S12). If the operation does not point to the pressing of the execution button 104 (No at S12), then the receiving unit 70 updates the destination specification screen 100 according to the operation information (S13), and the system control returns to S10.

On the other hand, when the operation points to the pressing of the execution button 104 (Yes at S12), the receiving unit 70 determines whether the operation points to the specification of a content (S14). When the operation points to the specification of a content (Yes at S14), the correcting unit 71 reads the positional information corresponding to the specified content, from the content management, table 62 (S15). However, if the operation does not point to the specification of a content (No at S14), then the correcting unit 71 reads, from the content management table 62, the positional information corresponding to each content under the specified scenario or the specified scene (S16). Then, the correcting unit 71 performs correction by adding predetermined height information to the height information of the coordinate data indicated by the positional information that is read (S17). The output unit 72 sends, to the terminal device 12, the positional information, which has the height information corrected by the correcting unit 71, as the positional information corresponding to the destination (S18). It marks the end of the operations.

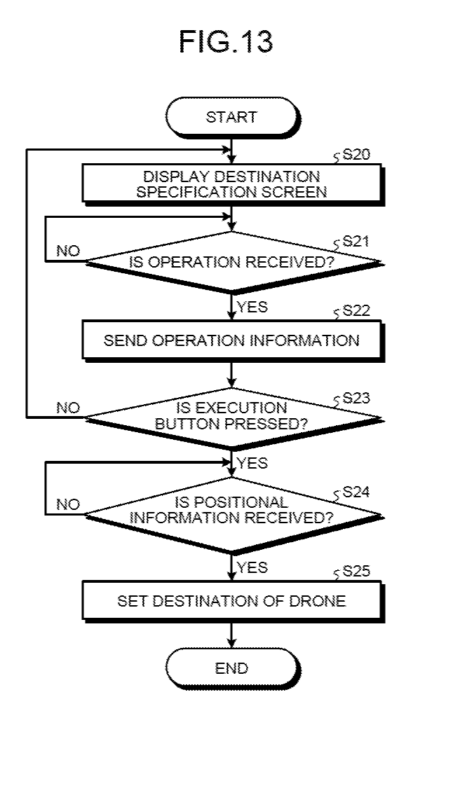

Given below is the explanation of a sequence of operations during a setting operation performed by the terminal device 12 for setting a destination of the drone 14. FIG. 13 is a flowchart for explaining an exemplary sequence of operations performed during a setting operation. Herein, the setting operation is performed at a predetermined timing such as the timing at which the image information of the destination specification screen 100 is received from the AR server 11.

As illustrated in FIG. 13, based on the image information of the destination specification screen 100 received from the AR server 11, the receiving unit 90 displays the destination specification screen 100 on the display unit 81 (S20). Then, the receiving unit 90 determines whether or not an operation with respect to the destination specification screen 100 is received (S21). If an operation is not received (No at S21), the system control returns to S21 and an operation is awaited. When an operation is received (Yes at S21), the receiving unit 90 sends operation information representing the received operation to the AR server 11 (S22). Then, the receiving unit 90 determines whether or not the received operation points to the pressing of the execution button 104 (S23). If the received operation does not point to the pressing of the execution button 104 (No at S23), then the system control returns to S20.

On the other hand, when the received operation points to the pressing of the execution button 104 (Yes at S23), it is determined whether or not the positional information corresponding to the destination is received from the AR server 11 (S24). If the positional information corresponding to the destination is not received (No at S24), the system control returns to S24 and the reception of the positional information corresponding to the destination is awaited.

On the other hand, when the positional information corresponding to the destination is received (Yes at S24), the setting unit 91 sets the received positional information corresponding to the destination in the destination information 30 of the drone 14 (S25). It marks the end of the operations.

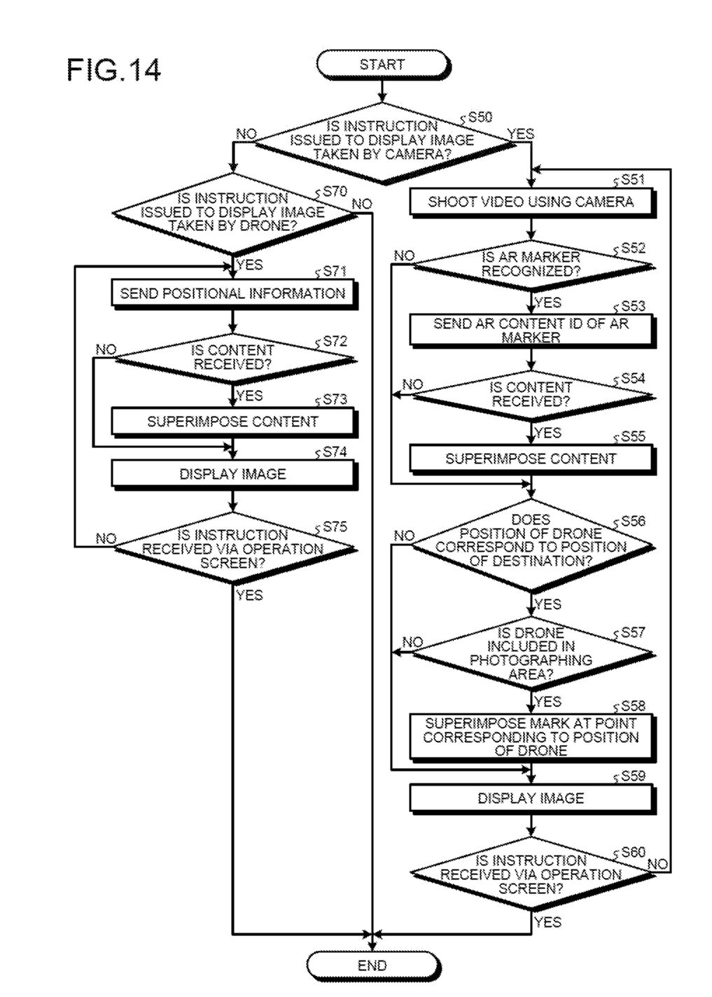

Given below is the explanation of a sequence of operations during a display control operation performed by the terminal device 12 for controlling the display of images. FIG. 14 is a flowchart for explaining an exemplary sequence of operations performed during a display control operation. Herein, the display control operation is performed at a predetermined timing such as the timing at which an instruction is received via an operation screen.

As illustrated in FIG. 14, the display control unit 92 determines whether or not an instruction for displaying the image taken by the camera 85 is issued (S50). If an instruction for displaying the image taken by the camera 85 is issued from an operation screen (Yes at S50), then the display control unit 92 shoots a video at a predetermined framerate using the camera 85 (S51). Then, the display control unit 92 performs image recognition regarding whether an AR marker is included in the taken image (S52). If an AR marker is not included in the taken image (No at S52), the system control proceeds to S56 (described later).

On the other hand, if an AR marker is included in the taken image (Yes at S52), then the display control unit 92 recognizes the AR content ID of the AR marker and sends it to the AR server 11 (S53).

The AR server 11 sends, to the terminal device 12, the content corresponding to the AR content ID received from the terminal device 12, along with the rotation angle and the magnification/reduction ratio of the concerned content.

The display control unit 92 determines whether or not a content is received from the AR server 11 (S54). If a content has not been received (No at S54), then the system control proceeds to S56 (described later).

On the other hand, when a content could be received (Yes at S54), the display control unit 92 superimposes the content, which is received from the AR server 11, with the received rotation angle and the magnification/reduction ratio on the image taken by the camera 85 (S55).

The display control unit 92 determines whether or not the positional information received from the drone 14 corresponds to the positional information of the destination of the drone 14 as set by the setting unit 91 (S56). If the positional information received from the drone 14 corresponds to the positional information of the destination (Yes at S56), the display control unit 92 determines whether or not the position of the drone 14 is included in the photographing area of the camera 85 (S57). If the position of the drone 14 is not included in the photographing area of the camera 85 (No at S57), then the system control proceeds to S59 (described later).

When the position of the drone 14 is included in the photographing area of the camera 85 (Yes at S57), the display control unit 92 superimposes a predetermined mark on that point in the image taken by the camera 85 which corresponds to the position of the drone 14 (S58).

The display control unit 92 displays the image on the display unit 81 (S59). Then, the display control unit 92 determines whether or not an instruction is received via an operation screen (S60). If no instruction is received (No at S60), then the system control returns to S51. On the other hand, when an instruction is received (Yes at S60), it marks the end of the operations.

Meanwhile, when an instruction for displaying the image taken by the camera 85 is not issued via an operation screen (No at S50), the display control unit 92 determines whether or not an instruction for displaying the image taken by the drone 14 is issued via an operation screen (S70). If an instruction for displaying the image taken by the drone 14 is issued via an operation screen (Yes at S70), then the display control unit 92 sends the positional information, which is received from the drone 14, to the AR server 11 (S71).

When a content is available corresponding to the positional information received from the terminal device 12, the AR server 11 sends the concerned content along with the rotation angle and the magnification/reduction ratio of the content to the terminal device 12.

The display control unit 92 determines whether or not a content is received from the AR server 11 (S72). If a content has not been received (No at S72), then the system control proceeds to S74 (described later).

On the other hand, when a content could be received (Yes at S72), the display control unit 92 superimposes the content, which is received from the AR server 11, with the received rotation angle and the magnification/reduction ratio on the image taken by the drone 14 (S73).

The display control unit 92 displays the image on the display unit 81 (S74). Then, the display control unit 92 determines whether or not an instruction is received via an operation screen (S75). If no instruction is received (No at S75), then the system control returns to S71. On the other hand, when an instruction is received (Yes at S75), it marks the end of the operations.

Meanwhile, when an instruction for displaying the image taken by the drone 14 is not issued (No at S70), it marks the end of the operations.

In this way, the AR server 11 stores the contents and the positional information in a corresponding manner. The AR server 11 receives specification of one of the stored contents from the terminal device 12. Then, the AR server 11 outputs the positional information corresponding to the specified content to the terminal device 12. Thus, by specifying the content corresponding to particular positional information instead of specifying the positional information itself, the AR server 11 can set the destination of the drone 14. That, enables achieving reduction in the efforts taken for setting of the destination.

Meanwhile, the AR server 11 divides a plurality of contents into one or more hierarchies and stores a plurality of content groups each including a plurality of contents. The AR server 11 receives specification of one of the hierarchies as the specification of one content group from among a plurality of content groups. Then, the AR server 11 outputs a plurality of sets of positional information corresponding to the plurality of contents included in the specified content group. As a result, in the AR server 11, by specifying a hierarchy, a plurality of sets of positional information corresponding to a plurality of contents included in the concerned hierarchy can be set at once as the destinations.

Meanwhile, the AR server 11 corrects the positional information corresponding to a content into positional information obtained by adding a predetermined value to the height included in the positional information. Then, the AR server 11 outputs the corrected coordinate data. As a result, the AR server 11 can fly the drone 14 in a stable manner.

The terminal device 12 receives the specification of a content. Then, the terminal device 12 receives the positional information corresponding to the specified content, from the AR server 11, and sets the positional information in the drone 14. Thus, by specifying a content, the terminal device 12 can be used to set the destination of the drone 14. That enables achieving reduction in the efforts taken for setting of the destination.

Moreover, the terminal device 12 receives an image taken by the drone 14, and displays the image on the display unit 81. As a result, the terminal device 12 enables confirmation of the image taken by the drone 14. Hence, the worker responsible for the inspection can check the condition of the site from the image taken by the drone 14 without having to go to the site.

Furthermore, the terminal device 12 takes an image. Moreover, the terminal device 12 sends the positional information to the AR server 11 and, when the content corresponding to the positional information is received from the AR server 11, displays on the display unit 81 a superimposed image formed by superimposing the content on the image that is taken. When a predetermined instruction is received from the user, the terminal device 12 displays the image taken by the drone 14 in place of the superimposed image on the display unit 81. As a result, the terminal device 12 can display an augmented reality image in which the content according to the captured position is superimposed on the taken image. Hence, for example, the terminal device 12 becomes able to support the factory inspection task of the worker. Moreover, when a predetermined instruction is received, the terminal device 12 displays the image taken by the drone 14 in place of the superimposed image on the display unit 81. Hence, the situation can be checked also using the image taken by the drone 14. Meanwhile, once the drone 14 reaches the destination, the display on the display unit 81 of the terminal device 12 can be changed to the image taken by the drone 14.

Furthermore, when the content corresponding to the positional information of the drone 14 is received from the AR server 11, the terminal device 12 displays on the display unit 81 a superimposed image formed by superimposing the concerned content on the image taken by the drone 14. That is, the terminal device 12 displays on the display unit 81 a superimposed image formed by superimposing the concerned content on the image taken by the drone 14. As a result, the terminal device 12 can display an augmented reality image in which the content according to the captured position of the drone 14 is superimposed on the image taken by the drone 14. Hence, the terminal device 12 becomes able to support the inspection performed using the image taken by the drone 14.

Meanwhile, when the positional information of the drone 14 corresponds to the positional information set as the destination and when the site corresponding to the positional information of the drone 14 is captured in the image taken by the camera 85, the terminal device 12 displays on the display unit 81 a superimposed image formed by superimposing a mark on the corresponding point in the image. As a result, the worker responsible for the inspection can understand from the mark displayed on the display unit 81 that the drone 14 is present up in the air.

Meanwhile, at the time of displaying an AR content, the terminal device 12 identifies an area according to the positional information of the terminal device 12 as calculated by the GPS unit 83 and the orientation information of the terminal device 12 as detected by the sensor unit 84. Herein, the area is equivalent to the displayed area of the terminal device 12 displayed on the display unit 81. Then, the terminal device 12 refers to the content management table, identifies the AR content ID of the positional information included in the concerned area, and displays the AR content corresponding to the concerned AR content ID on the display unit 81 of the terminal device 12.

### Second Embodiment

Given below is the explanation of a second embodiment. Herein, the system 10, the terminal device 12, and the drone 14 according to the second embodiment have an identical configuration to the configuration illustrated in FIGS. 1, 2, and 9 according to the first embodiment. Hence, that explanation is not repeated.

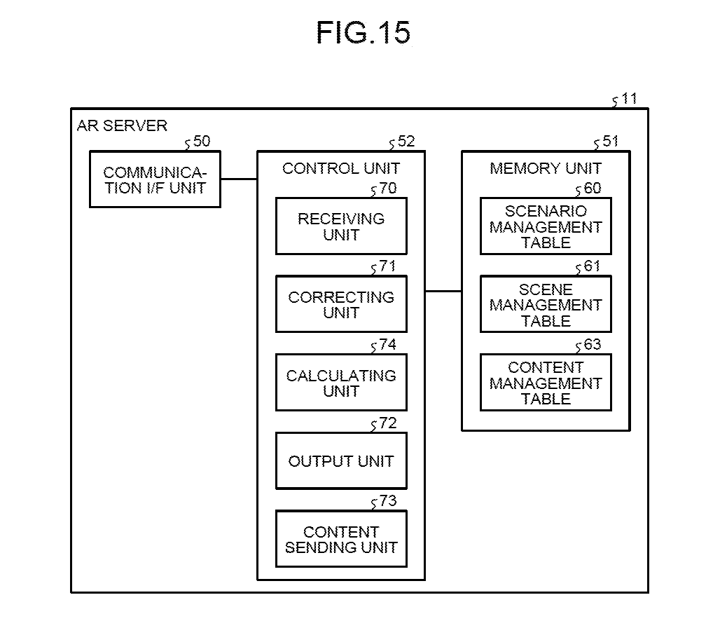

FIG. 15 is a diagram that schematically illustrates a functional configuration of the AR server according to the second embodiment. The configuration of the AR server 11 according to the second embodiment is substantially identical to the configuration illustrated in FIG. 3 according to the first embodiment. Hence, the identical constituent elements are referred to by the same reference numerals, and the explanation is mainly given about the differences.

The memory unit 51 is used to store a content management table 63 instead of storing the content management table 62.

The content management table 63 represents memory data of the information related to contents. In the content management, table 63, contents registered in a corresponding manner to the scenes are stored. For example, in the content management table 63, for each target object for inspection, the positional information of the target, object and the contents to be displayed are registered along with the display format. In the content management table 63 according to the second embodiment, the positional information of the target object is stored in the form of coordinate data of a reference sign and relative position information derived from the coordinate data of the reference sign.

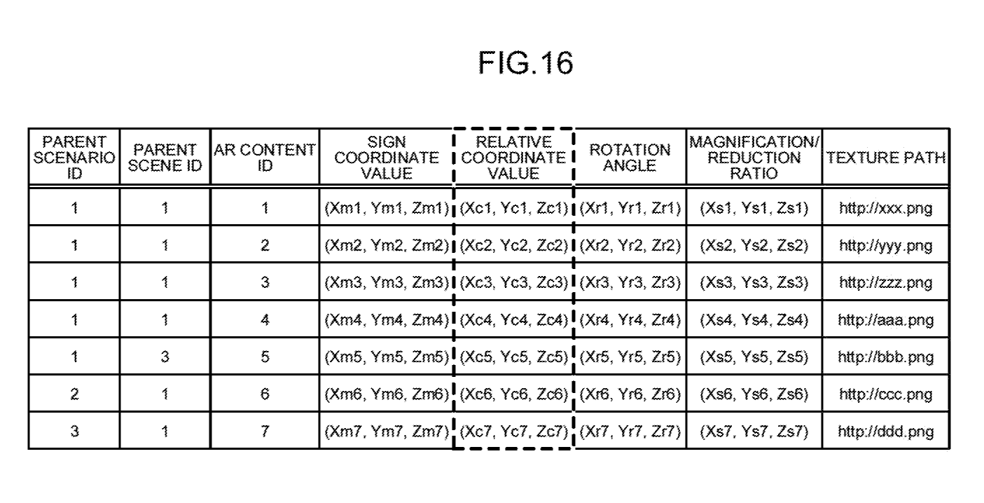

FIG. 16 is a diagram illustrating an exemplary data configuration of the content management table according to the second embodiment. As illustrated in FIG. 16, the content management table 63 includes “parent scenario ID”, “parent scene ID”, “AR content ID”, “sign coordinate value”, “relative coordinate value”, “rotation angle”, “magnification/reduction rate”, and “texture path” as items. The item “parent scenario ID” represents an area in which scenario IDs of such scenarios are stored which have the concerned contents associated thereto. The item “parent scene ID” represents an area in which scene IDs of the scenes associated with contents are stored. The item “AR content ID” represents an area in which AR content IDs assigned to the contents are stored. The item “sign coordinate value” represents an area in which the positional information indicating the position of a sign serving as the reference position is stored. Herein, the sign can be a position of reference such as the position of a particular building in the factory or a landmark. Moreover, there can be a different sign for each content, or there can be a common sign among some or all contents.

In the second embodiment, in the item “sign coordinate value” is stored the positional information indicating the position of the sign, which serves as the reference position, in the geodetic system of latitude, longitude, and height. The item “relative position value” represents an area for storing the positional information indicating, in relative coordinates, the display position of the content with reference to the sign position. In the item “relative coordinate value” is stored, as the display position of the content, the positional information indicating the relative position of the target object for inspection from the sign position in a predetermined coordinate system. For example, in the item “relative coordinate value”, the distances in the north-south direction, the east-west direction, and the height direction of the target object for inspection with reference to the sign position are stored. The item “rotation angle” represents an area in which the angle of rotation at the time of displaying a content is stored. The item “magnification/reduction ratio” represents an area in which the magnification ratio or the reduction ratio at the time of displaying a content is stored. The item “texture path” represents an area in which information related to the storage destinations of the contents to be displayed are stored.

Returning to the explanation with reference to FIG. 15, the control unit 52 further includes a calculating unit 74.

The calculating unit 74 performs various calculations. For example, when the receiving unit 70 receives specification of a destination of the drone 14 via the destination specification screen 100, the calculating unit 74 reads from the content management table 62 the positional information of the sign coordinate value and the positional information of the relative coordinate value corresponding to the specified content. Meanwhile, when the destination is specified using a scenario or a scene, the correcting unit 71 reads from the content management table 62 the positional information of the sign coordinate value and the positional information of the relative coordinate value corresponding to each content under the scenario or the scene specified as the destination.

The calculating unit 74 calculates, from the position indicated by the positional information of the sign coordinate value that is read, coordinate data of the position indicated by the positional information of the relative coordinate value. For example, the calculating unit 74 performs approximation such as 0.00001 [degree]≈1 [m] for the latitude and the longitude of the geodetic system; and calculates, in the geodetic system, coordinate data of the position of the target object for inspection as indicated by the positional information of the relative coordinate value. Meanwhile, regarding the height, the calculation is performed by adding the height information indicated by the positional information of the relative coordinate value to the height information of the coordinate data indicated by the positional information of the sign coordinate value.

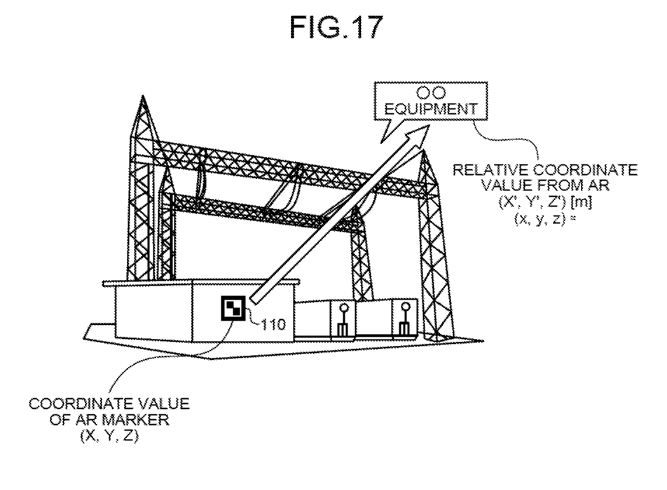

FIG. 17 is a diagram that schematically illustrates an example of calculating the position of the target object for inspection. In the example illustrated in FIG. 17, as the sign coordinate value, coordinate data (X, Y, Z) of an AR marker 110 as measured using the GRS is illustrated, and a relative coordinate value (X′, Y′, Z′) indicated by the relative position of the position of OO equipment, which is to be inspected, from the AR marker 110 is illustrated. The calculating unit 74 calculates, from the coordinate data (X, Y, Z), coordinates (x, y, z) of the position indicated by the relative coordinate value.

The correcting unit 71 performs correction by adding predetermined height information to the height information of the coordinate data in the geodetic system of the target object for inspection as calculated by the calculating unit 74.

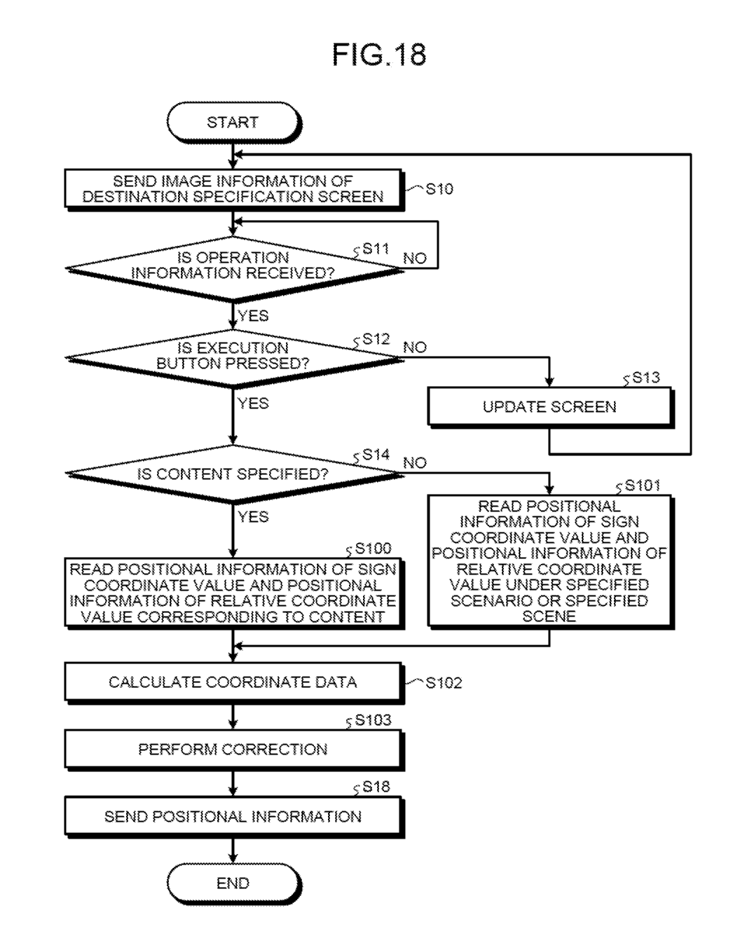

FIG. 18 is a flowchart for explaining an exemplary sequence of operations performed during the information processing according to the second embodiment. Herein, the information processing according to the second embodiment is substantially identical to the information processing illustrated in FIG. 12 according to the first embodiment. Hence, the identical constituent elements are referred to by the same reference numerals, and the explanation is mainly given about the differences.

When the operation points to the specification of a content (Yes at S14), the calculating unit 74 reads from the content management table 62 the positional information of the sign coordinate value and the positional information of the relative coordinate value corresponding to the specified content (S100). On the other hand, when the operation does not point to the specification of a content (No at S14), the correcting unit 71 reads from the content management table 62 the positional information of the sign coordinate value and the positional information of the relative coordinate value corresponding to each content under the specified scenario or the specified scene (S101).

The calculating unit 74 calculates, from the position indicated by the positional information of the sign coordinate value that is read, the coordinate data of the position indicated by the positional information of the relative coordinate value (S102). Then, the correcting unit 71 performs correction by adding predetermined height information to the height information of the coordinate data calculated by the calculating unit 74 (S103).

In this way, the AR server 11 stores the positional information of the sign corresponding to a content and stores the relative positional information derived from the positional information of the sign. Moreover, based on the positional information of the sign and the relative positional information, the AR server 11 calculates the positional information of the content. Then, the AR server 11 outputs the calculated positional information. As a result, even when the position of a content is stored in the form of the relative position from the positional information of the reference sign, the AR server 11 can set the position of the content as a destination of the drone 14.

### Third Embodiment

Till now, the explanation was given about the embodiments of the disclosed device. Beyond that, it is also possible to implement various illustrative embodiments. Given below is the explanation of other embodiments according to the present invention.

For example, in the embodiments described above, the explanation is given for an example in which the terminal device 12 sets the positional information as a destination in the drone 14 via wireless communication. However, the disclosed device is not limited to that case. Alternatively, for example, at the time of setting the destination, the terminal device 12 and the drone 14 can be connected for wired communication using a universal serial bus (USB), and the positional information can be set as a destination in the drone 14 using wired communication.

Moreover, in the embodiments described above, the explanation is given for a case in which the AR server 11 outputs the positional information to be set. as a destination to the terminal device 12, and then the terminal device 12 sets the positional information in the drone 14. However, the disclosed device is not limited to that case. Alternatively, for example, the AR server 11 can set the positional information to be set as a destination in the drone 14. For example, the AR server 11 can output an instruction to the unmanned aerial vehicle for which the positional information corresponding to the specified content serves as a destination.

Furthermore, in the embodiments described above, the explanation is given for a case in which AR contents and positional information are stored in a corresponding manner. However, the disclosed device is not. limited to this case. Alternatively, for example, the contents are not limited to AR contents.

Moreover, in the embodiments described above, the explanation is given for a case in which, regarding an AR marker that is captured in an image taken by the terminal device 12, the AR content ID is sent, to the AR server 11 and a content is obtained. However, the disclosed device is not limited to that case. For example, the terminal device 12 can send, to the AR server 11, the positional information measured by the GPS unit 83 and can obtain a content.

Meanwhile, the drone 14 is installed with illumination such as a light emitting diode (LED). When the drone 14 is stationary over the inspection site, if the user performs a predetermined operation using the terminal device 12, the illumination installed in the drone 14 can be switched ON so that the inspection site is illuminated. As a result, for the worker who has reached the inspection site, it becomes easier to perform the inspection.

Moreover, the configuration can be such that, when the drone 14 reaches a destination, the terminal device 12 displays a pop-up indicating the arrival of the drone 14 based on the corresponding positional information. When the pop-up is touched, the displayed image is changed to the image taken by the drone 14.

Furthermore, when the current position of the drone 14 is determined to be within a predetermined range from the destination, videos can be taken at a predetermined framerate using the camera 23.

Meanwhile, the constituent elements of the devices illustrated in the drawings are merely conceptual, and need not be physically configured as illustrated. The constituent elements, as a whole or in part, can be separated or integrated either functionally or physically based on various types of loads or use conditions. For example, the constituent elements of the AR server 11 such as the receiving unit 70, the correcting unit 71, the output unit 72, the content sending unit 73, and the calculating unit 74 can be integrated in an appropriate manner. Moreover, for example, the constituent elements of the terminal device 12 such as the receiving unit 90, the setting unit 91, and the display control unit 92 can be integrated in an appropriate manner. Furthermore, the constituent elements of the AR server 11 and the terminal device 12 either can be integrated in an appropriate manner or can be separated into operations of a plurality of constituent elements in an appropriate manner. Moreover, all or some of the operational functions implemented in the constituent elements can be implemented using a CPU and using computer programs analyzed and executed by the CPU, or can be implemented using hardware such as a wired logic.

### [Information Processing Program]

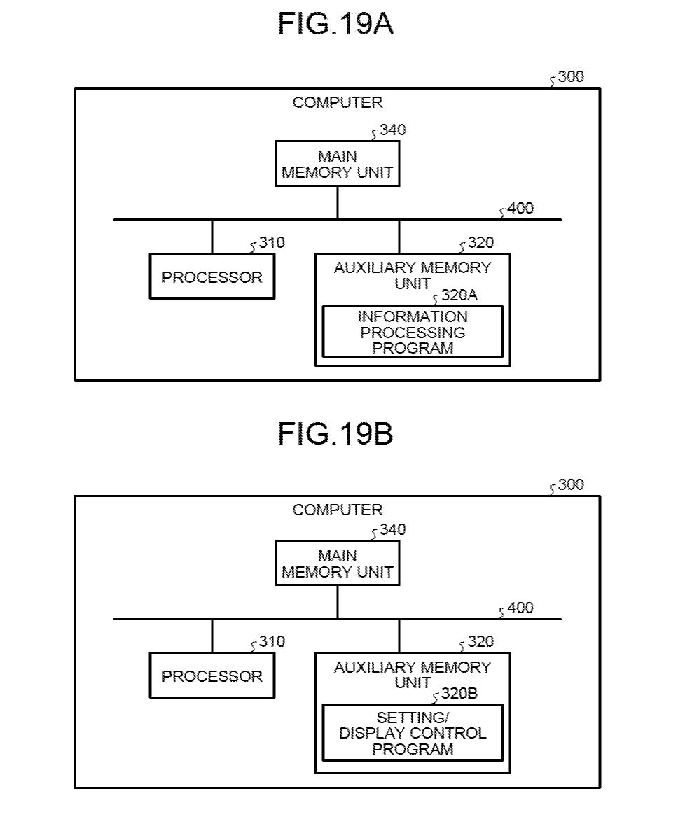

The various operations explained in the embodiments can be implemented by executing computer programs, which are written in advance, in a computer system such as a personal computer or a workstation. Given below is the explanation of a computer system that executes computer programs having the same functions as the functions explained in the embodiments. Firstly, the explanation is given about an information processing program for supporting the setting of a destination of the drone 14, FIG. 19A is a diagram illustrating an exemplary computer that executes the information processing program.

As illustrated in FIG. 19A, a computer 300 includes a central processing unit (CPU) 310, a hard disk drive (HDD) 320, and a random access memory (RAM) 340. The constituent elements 300 to 340 are connected to each other via a bus 400.

The HDD 320 is used to store in advance an information processing program 320A that implements functions identical to the functions of the correcting unit 71, the output unit 72, the content sending unit 73, and the calculating unit 74. Meanwhile, the information processing program 320A can be split in an appropriate manner.

Moreover, the HDD 320 is used to store a variety of information. For example, the HDD 320 is used to store a variety of data used by the OS and used in various operations.

The CPU 310 reads the information processing program 320A from the HDD 320, and performs operations identical to the operations performed by the constituent elements according to the embodiments. That is, the information processing program 320A performs operations identical to the operations performed by the receiving unit 70, the correcting unit 71, the output unit 72, the content sending unit 73, and the calculating unit 74.

Meanwhile, the information processing program 320A need not always be stored in the HDD 320 from the beginning.

### [Setting/Display Control Program]

Given below is the explanation of a setting/display control program(Information processing program), FIG. 19B is a diagram illustrating an exemplary computer that executes the setting/display control program. Herein, the constituent elements identical to the constituent elements illustrated in FIG. 19A are referred to be the same reference numerals, and the explanation thereof is not repeated.

As illustrated in FIG. 19B, the HDD 320 is used to store a setting/display control program 320B that implements functions identical to the functions of the receiving unit 90, the setting unit 91, and the display control unit 92. Meanwhile, the setting/display control program 320B can be split in an appropriate manner.

Moreover, the HDD 320 is used to store a variety of information. For example, the HDD 320 is used to store a variety of data used by the OS and used in various operations.

The CPU 310 reads the setting/display control program 320B from the HDD 320, and performs operations identical to the operations performed by the constituent elements according to the embodiments. That is, the setting/display control program 320B performs operations identical to the operations performed by the receiving unit 90, the setting unit 91, and the display control unit 92.

Meanwhile, the setting/display control program 320B also need not always be stored in the HDD 320 from the beginning.

For example, the information processing program 320A and the setting/display control program 320B can be stored in a portable physical medium such as a compact disk read only memory (CD-ROM), a digital versatile disk (DVD), a magnetic optical disk, or an IC card. Then, the computer 300 can obtain the computer programs from the portable physical medium, and execute the computer programs.

Alternatively, the computer programs can be stored in another computer (or a server) that is connected to the computer 300 via a public line, the Internet, a local area network (LAN), or a wide area network (WAN). Then, the computer 300 can obtain the computer programs from the other computer (or the server), and execute the computer programs.

According to an aspect of the present invention, it becomes possible to reduce the efforts taken in setting a destination.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a memory that stores a content in association with positional information, the content being to be displayed in a superimposed manner on an AR display terminal; and
a processor that executes a process including:
receiving, from a terminal device capable of sending a signal for setting a target position of an unmanned aerial vehicle, specification of any one of contents stored in the memory; and
outputting positional information corresponding to a content specified in the received specification to the terminal device.

2. The information processing device according to claim I, wherein the positional information stored in the memory is used in controlling display position of a content which is to be displayed in a superimposed manner on the AR display terminal.

3. The information processing device according to claim 1, wherein the positional information stored in the memory corresponds to placement location of a particular sign corresponding to the content.

4. The information processing device according to claim 1, wherein the AR display terminal and the terminal device represent same device.

5. The information processing device according to claim 1, wherein
the memory stores a plurality of content groups each including a plurality of contents,
the receiving includes receiving specification of any one content group from among the plurality of content groups, and
the outputting includes outputting a plurality of sets of positional information each corresponding to one of a plurality of contents included in the specified content group.

6. The information processing device according to claim 1, wherein
the memory stores positional information of a sign corresponding to the content and stores relative positional information derived from the positional information of the sign,
the process further including calculating positional information of the content, based on the positional information of the sign and the relative positional information, and wherein
the outputting includes outputting positional information calculated.

7. The information processing device according to claims 1, the process further including correcting positional information corresponding to the content into positional information obtained by adding a predetermined value to value of height specified in concerned positional information, and wherein
the outputting includes outputting positional information corrected.

8. An information processing device comprising:
a memory that stores a content in association with positional information, the content being to be displayed in a superimposed manner on an AR display terminal;
a processor that executes a process including:
receiving, from a terminal device, specification of any one of contents stored in the memory; and
outputting an instruction to an unmanned aerial vehicle for which positional information corresponding to a content specified in the received in the specification serves as destination.

9. The information processing device according to claim 8, wherein the positional information stored in the memory is
used in controlling display position of a content which is to be displayed in a superimposed manner on the AR display terminal.

10. The information processing device according to claim 8, wherein the positional information stored in the memory corresponds to placement location of a particular sign corresponding to the content.

11. The information processing device according to claim 8, wherein the AR display terminal and the terminal device represent same device.

12. The information processing device according to claim 8, wherein
the memory stores a plurality of content groups each including a plurality of contents,
the receiving includes receiving specification of any one content group from among the plurality of content groups, and
the outputting includes outputting a plurality of sets of positional information each corresponding to one of a plurality of contents included in the specified content group.

13. The information processing device according to claim 8, wherein
the memory stores positional information of a sign corresponding to the content and stores relative positional information derived from the positional information of the sign,
the process further including calculating positional information of the content based on the positional information of the sign and the relative positional information, and wherein
the outputting includes outputting positional information calculated.

14. The information processing device according to claims 8, the process further including correcting positional information corresponding to the content into positional information obtained by adding a predetermined value to value of height specified in concerned positional information, and wherein
the outputting includes outputting positional information corrected.

15. A non-transitory computer-readable recording medium having stored therein an information processing program that causes a computer to execute a process comprising:
receiving, from a terminal device capable of sending a signal for setting a target position of an unmanned aerial vehicle, specification of any one of contents stored in a memory that is used to store a content in association with positional information, the content being to be displayed in a superimposed manner on an AR display terminal; and
outputting positional information corresponding to the specified content to the terminal device.

16. An information processing method comprising:
receiving, by a computer, from a terminal device capable of sending a signal for setting a target position of an unmanned aerial vehicle, specification of any one of contents stored in a memory that is used to store a content in association with positional information, the content being to be displayed in a superimposed manner on an AR display terminal; and
outputting, by the computer, positional information corresponding to the specified content to the terminal device.

17. An information processing method comprising:
receiving from a terminal device, specification of any one of contents stored in a memory that is used to store contents in association with positional information, the content being to be displayed in a superimposed manner on an AR display terminal; and
outputting,, by a computer, an instruction to an unmanned aerial vehicle for which positional information corresponding to the specified content serves as destination,

18. A non-transitory computer-readable recording medium having stored therein an information processing program that causes a computer to execute a process comprising:
receiving, from a terminal device, specification of any one of contents stored in a memory that is used to store contents in association with positional information, the content being to be displayed in a superimposed manner on an AR display terminal; and
outputting an instruction to an unmanned aerial vehicle for which positional information corresponding to the specified content serves as destination.

19. A terminal device comprising:
a processor that executes a process including:
receiving specification of any one of contents to be displayed in a superimposed manner on an AR display terminal; and
obtaining positional information corresponding to a content specified in the received specification from an information processing device, which stores positional information in association with contents, and setting the obtained positional information as destination information of an unmanned aerial vehicle.

20. The terminal device according to claim 19, the process further including receiving an image which is taken by the unmanned aerial vehicle and
displaying the image on a display unit.

21. The terminal device according to claim 20, wherein
the displaying includes detecting a content which is registered in a corresponding manner to the positional information obtained by the obtaining unit that obtains positional information of the terminal device and, when a predetermined instruction is received during display on the display unit of a superimposed image formed by superimposing the detected content on an image taken by the photographing unit that takes an image, displaying an image taken by the unmanned aerial vehicle on the display unit.

22. The terminal device according to claim 20, wherein
the displaying includes when an image taken by the unmanned aerial vehicle includes position corresponding to positional information that is stored in the memory in a corresponding manner with respect to a particular content, displaying the particular content in a superimposed manner on the image taken by the unmanned aerial vehicle.

23. The terminal device according to claim 20, wherein
the displaying includes when the obtained positional information of the unmanned aerial vehicle is detected to indicate a position included in an image taken by a photographing, displaying a mark corresponding to the unmanned aerial vehicle in a superimposed manner on the image.

24. A setting method comprising:
obtaining when specification of any one of contents to be displayed in a superimposed manner on an AR display terminal, positional information corresponding to the specified content from an information processing device which stores contents and positional information in a corresponding manner; and
setting, by a computer, the obtained positional information as destination information of an unmanned aerial vehicle.

25. A non-transitory computer-readable recording medium having stored therein an information processing program that causes a computer to execute a process comprising:
obtaining, when specification of any one of contents to be displayed in a superimposed manner on an AR display terminal, positional information corresponding to the specified content from an information processing device which stores contents and positional information in a corresponding manner; and
setting the obtained positional information as destination information of an unmanned aerial vehicle.
